(19) United States
(12) Patent Application Publication
(10) Pub. No.: US 2025/0326665 A1
(43) Pub. Date: Oct. 23, 2025

(54) SYSTEMS AND METHODS FOR SEPARATING AND REMOVING WATER SOLUBLE ORGANICSFROM AQUEOUS STREAMS

(71) Applicant: Harikrishnan Parthasarathy, Flowery Branch, GA (US)

(72) Inventor: Harikrishnan Parthasarathy, Flowery Branch, GA (US)

(21) Appl. No.: 19/183,797

(22) Filed: Apr. 19, 2025

Related U.S. Application Data
(60) Provisional application No. 63/636,793, filed on Apr. 21, 2024.

(51) Int. Cl. C02F 1/461; C02F 1/467; C02F 101/30

(52) U.S. Cl. CPC C02F 1/46109; C02F 1/4672; C02F 2001/46138; C02F 2101/30; C02F 2201/006; C02F 2201/4611; C02F 2201/4613; C02F 2201/46135; C02F 2201/4614; C02F 2201/4616

(57) ABSTRACT

The systems and methods of this disclosure generally relates to electro oxidation techniques and chemical processes or systems, to remove water soluble organics (WSOs) dissolved organics or hexine extractable organics. from produced water and wastewater aqueous streams in industrial processes or systems, from produced water or dirty water from oil wells.

### CLAIM OF PRIORITY

Priority is herewith claimed under 35 U.S.C § [119](e) from copending provisional patent application No. 63/636,793, filed Apr. 21, 2024, titled systems and methods for separating and removing water soluble organics from aqueous streams the disclosure of this provisional patent application is incorporated by reference herein in their entirety.

### RELATED APPLICATIONS

U.S. application Ser. No. 17/327,781, titled System for Quick Response, Transportable, Stand-Alone System for Removing Volatile Compounds from Contaminated Fluid Streams, and Method of Use Thereof, filed on May 24, 2021, are incorporated by reference herein in their entirety.

U.S. application Ser. No. 19/066,746 titled, systems and methods for preventing colored emissions in chemical processes, filed on Mar. 10, 2025 are incorporated by reference herein in their entirety.

### FIELD

This disclosure generally relates to chemical processes or systems, more particularly, to remove water soluble organics (WSOs) from aqueous streams in industrial processes or systems, or from produced water (e.g., dirty water from oil wells). As used herein, WSO's may also refer to dissolved organics or hexine extractable organics.

This disclosure also generally relates to chemical processes or systems, more particularly, to separate WSOs from aqueous streams in industrial processes or systems, or from produced water.

This disclosure generally also relates to chemical processes or systems, more particularly, to convert water soluble organics in aqueous streams to free oils and/or dispersed oils.

Moreover, this disclosure generally relates to chemical processes or systems, more particularly, to remove strong oily water emulsions and water soluble oily components from produced and process wastewater.

Moreover, this disclosure general relates to chemical processes or systems, more particularly, to break aromatics, cyclic organics, saturated or unsaturated gasoline and diesel range organics into saturated or semi saturated long chain organics.

Moreover, this disclosure also generally relates to chemical processes or systems, more particularly, to negate negative colloidal charges (which breaks emulsions) and allows for agglomeration of saturated or semi saturated long chain organics (for example, into a suspended or free phase layer).

Furthermore, this disclosure generally relates to chemical processes or systems, more particularly, to increase the commercial longevity of an oil well (e.g., offshore oil well) by increasing the total oil and gas possible from a produced water stream from the oil well.

### BACKGROUND

In some industrial processes, such as extracting oil and/or gas at offshore sites, produced water that is pumped from production facilities, such as remote or offshore oil wells, has concentrations of water soluble organics. In some instances, the produced water or discharge water produced as a part of overall extraction or processing of oil and/or gas can have a significant water soluble organics (WSO) concentration or can further be acidic, for example due to conventional methods and systems for removing WSOs which utilize acids and implement processes which may cause an acidic byproduct.

As will be appreciated, emissions from industrial processes into natural environments, such as the ocean, are becoming increasingly regulated. In recent years the U.S. Environmental Protection Agency has even for example utilized satellite enforcement of environmental regulations on offshore platforms to detect unacceptable levels of emissions.

Accordingly, there is a need in the art for systems and methods for removing water soluble organics from aqueous streams, particularly in applications where the aqueous streams are discharged into another environment, for example a natural environment.

### SUMMARY

This summary is provided to introduce a selection of concepts or aspects in a simplified form that are further described below in the detailed description. This summary is not intended to identify key features or essential features of the claimed subject matter, nor is it intended to be used in isolation as an aid in determining the scope of the claimed subject matter.

Certain aspects according to the present disclosure are directed towards systems and methods for removal of WSOs from an aqueous stream.

In one aspects a system is provided for removing water soluble organics from an aqueous stream, comprising a titanium anode comprising a mixed metal oxide (MMO) coating, a titanium cathode, a channel between the anode and the cathode, and a power source to apply electricity across the channel.

In some aspects the system is formed into a cartridge configured for reversing polarity of the electrodes that may be switched at a frequency in the range of 2 minutes to 360 minutes, however is not limited as such and may be switched in a range of 360 minutes to 720 minutes.

In some aspects the system is formed into a replaceable cartridge.

In some aspects the system comprises a plurality of anodes and a plurality of cathodes. In some aspects the MMO coating is iridium oxide.

In some aspects the MMO coating comprises iridium oxide, ruthenium oxide, tantalum oxide and platinum oxide.

In some aspects the titanium cathode comprises an MMO coating.

In some aspects a voltage of 5-10 V is applied across the channel.

In some aspects a current of 10-25 amps is applied across the channel.

In some aspects the polarity of the anode and the cathode are configured to be periodically switched.

The following is context and development history that is described in greater detail herein, in the Detailed Description: “discharge water” (e.g., water volumes or streams periodically or continuously discharged to the sea or other body(ies) of water) that is emitted from “produced water” or “dirty water” production facilities and/or from “produced water” or “dirty water” processing facilities, and/or that is likely to have a significant water soluble organics concentration, is highly regulated or becoming highly regulated. Moreover, the “discharge water that is emitted from remote, “dirty water” production facilities, for example, from off shore oil or gas platforms; or that is likely to have a significant water soluble organics concentration; or that is likely to be acidic, is highly regulated or becoming highly regulated.

In some aspects, oil or gas wells are considered “dirty water” “production facilities” in that they mainly or primarily produce/extract water that is not readily obtainable or that has been sequestered in a substrate or material, and that happens to have a small but economically valuable fraction that is oil and gas.

In some aspects, removing, capturing, and redirecting the oil and/or gas fraction is often time associated with one or more related industrial channels-of-trade, and/or associated with specific regulations and understandings of what is acceptable.

In some aspects, processing “dirty water”, e.g., what remains of the “produced water” after processing for the oil and gas, is often times associated with its own, different industrial channels-of-trade and/or with different regulations and understandings of what is acceptable.

Development of some aspects according to the present disclosure can be outlined as follows: a conventional electro-oxidation system/process is provided. For example, an anode and cathode connected to a voltage source. In some aspects, the anode and/or the cathode are aluminum. In some aspects, if metals, oils, or water soluble organics are in the dirty water, for example, then flocculation will occur with some floe falling out of solution and settling at the bottom of a reaction tank, for example.

In some aspects, there are deficiencies, e.g., (1) requires replacement electrodes because the aluminum anode and/cathode are consumed by the electro-oxidation reaction (aluminum in solution is toxic and a regulated contaminant, so introducing it into the dirty water stream is less than preferred); (2) produces quantities of hydrogen gas which, for a remote facility like an offshore oil or gas platform, is considered to be extremely dangerous (this is due to the need for managing and channeling the hydrogen gas that is produced and the associated explosion risk); (3) requires large quantities of supplies, like filter media and aluminum electrodes, and space to store and stage the supplies, and space to store and package the material wastes (e.g., space to store, package, and ship saturated filter-media laden with highly concentrated contaminants) (if dealing with a remote facility like an offshore oil or gas platform, then it also requires periodic and consistent transportation and restocking of supplies, and requires handling and shipping of material wastes, and then the associated logistics and processing infrastructure to manage those shipped supplies/waste); (4) requires relatively large quantities of labor to manage reaction tank maintenance and upkeep (e.g., to maintain and clean reaction tanks, and to replace electrodes), to manage filter media exchanges, to manage supply stocking and processing, and to manage waste processing and shipping (if dealing with a remote facility like an offshore oil or gas platform, then it also requires having a crew that is willing and able to handle all of the usual tasks of field work plus the added tasks described above); and (5) for those situations where the produced/dirty water that is being processes is acidic or has been acidified, then the systems and sub-systems will also have to be maintained, due to the effects of corrosion, or treated to prevent corrosion (this magnifies the above listed issues, e.g., more supplies, more labor, more work).

In some aspects, an electro-chlorination system/process is provided. For example, a titanium anode and titanium cathode connected to a voltage source. In some aspects, the anode alone is coated in a mixed metal oxide, namely, iridium oxide (a type of mixed metal oxide). In some aspects, the voltage/current is typically about 5-10 V DC and about 25 amps. In some aspects, if metals, oils, or water soluble organics are in the dirty water, for example, then the system/process will produce hydrogen gas, molecular halogen (e.g., fluorine gas, chlorine gas, bromine gas, iodine gas), for example, and/or associated halide compounds or complexes (e.g., fluoride compounds or complexes or mixtures, chloride compounds or complexes or mixtures, bromide compounds or complexes or mixtures, iodide compounds or complexes or mixtures).

In some aspects, there are deficiencies, e.g., (1) requires replacement electrodes (the cathode, in particular) in a short period of time (e.g., about two days), and/or maintenance of electrodes (the anode, in particular) in a short period of time (due to rapid electrode fouling/scaling); (2) produces quantities of chlorine gas and/or bromine gas which, for a remote facility like an offshore oil or gas platform, is considered to be extremely dangerous (this is due to need for managing and channeling the chlorine gas and/or bromine gas that is produced and the associated corrosion/health risks); (3) requires space to store and stage the supplies, like replacement titanium cathodes, and space to store and package the material wastes (e.g., solids removed and collected from defouling/descaling the coated titanium anodes) (if dealing with a remote facility like an offshore oil or gas platform, then it also requires periodic and consistent transportation and restocking of supplies, and requires handling and shipping of material waste, and then the associated logistics and processing infrastructure to manage those supplies/waste); and (4) requires relatively large quantities of labor to manage reaction tank maintenance and upkeep (e.g., to maintain and clean reaction tanks, and to replace electrodes), to manage supply stocking and processing, and to manage waste processing and shipping (if dealing with a remote facility like an offshore oil or gas platform, then it also requires having a crew that is willing and able to handle all of the usual tasks of field work plus the added tasks described above) (if dealing with a remote facility like an offshore oil or gas platform, then it also requires generating and maintaining significant electricity production for the 5-10 V DC/25 amp electro-oxidation system/process).

In some aspects, an electro-oxidation system/process including: a titanium anode coated with platinum, and a mixed metal oxide combination having two or more of ruthenium oxide, iridium (IV) oxide, tantalum oxide, or any combination thereof, is provided. For example, a mixed metal oxide, titanium anode and a titanium cathode connected to a voltage source. In some aspects, the mixed metal oxide, titanium anode is specifically coated in a mixed metal oxide combination (two or more mixed metal oxides, namely, those having rare earth metal elements) and platinum (distinguished from platinum oxide; platinum is a noble metal). In some aspects, the voltage/current is typically about 3 V DC and about 25 amps. In some aspects, if water soluble organics are in the dirty water, for example, then the system/process will convert water soluble organics into free oil (available for recovery) without need for acid treatment to the dirty water. In some aspects, the process/system only produces quantities of generally harmless carbon dioxide gas (e.g., hydrocarbons) as well as generated H2O (clean water) with no added toxicity to the dirty water or discharge water, and/or with no added acidity needed. In some aspects, if dealing with a remote facility like an offshore oil or gas platform, then the process/system demands significantly less electricity over time than the 5-10 V DC/25 amps conventional systems/processes.

In some aspects, an electro-oxidation system/process including a coated titanium anode and an equivalently coated titanium cathode connected to a voltage source is provided. For example, the anode and the cathode are coated in a mixed metal oxide, namely, any of ruthenium oxide, iridium (IV) oxide, tantalum oxide, or those listed above and herein. In some aspects, the process/system requires replacement electrodes but only after a significantly longer period of time (e.g., about one (1) year); requires significantly fewer types of supplies and less quantities of supplies, like filter media and replacement electrodes, and requires significantly less space to store and stage the supplies (if dealing with a remote facility like an offshore oil or gas platform, requires significantly fewer trips and less logistics for transportation and restocking of supplies); and requires significantly less labor to manage the systems/processes.

In some aspects, an electro-oxidation system/process including a mixed metal oxide and platinum, titanium anode, and a mixed metal oxide and platinum, titanium cathode connected to a voltage source is provided. For example, the mixed metal oxide and platinum, titanium electrodes each may specifically include a mixed metal oxide combination (two or more mixed metal oxides, namely, two or more of ruthenium oxide, iridium (IV) oxide, tantalum oxide, or those listed above and herein, or any combination thereof). In some aspects, reversed polarity is used to defoul/descale the electrode that was once the anode and is now the cathode (after the reversal of polarity), such that the system/process does not have to be shut down or bypassed. In some aspects, the electrodes are configured as a selectively replaceable cartridge that it is an easy replacement piece when the electrodes reach the end of their useful life. As such, the system/process is consistent in producing efficient and effective results (e.g., acceptable discharge water) even during maintenance and upkeep. Moreover, the system/process has a reduced size and footprint, a reduced weight, and a reduced capital expenditure and operating cost.

Additional objects, advantages, and novel features of the invention will be set forth in part in the description which follows, and in part will become apparent to those skilled in the art upon examination of the following, or can be learned by practice of the invention.

### BRIEF DESCRIPTION OF THE DRAWINGS

Aspects of the technology presented herein are described in detail below with reference to the accompanying drawing figures, wherein:

FIG. 1 illustrates a typical example oil, gas, water production process, that utilizes acid treatment and secondary removal of water soluble organics (WSOs) in accordance with some aspects of the present technology;

FIG. 2 illustrates a typical example oil, gas, water production process, that utilizes an electro oxidation unit that converts WSOs dispersed oil without the use of acid treatment in accordance with some aspects of the present technology;

FIG. 3. illustrates example electrooxidation aspects of WSO removal, in accordance with some aspects of the present technology;

FIG. 4 illustrates example electrooxidation cell and MMO coatings in accordance with some aspects of the present technology;

FIGS. 5A, B, & C illustrates an example electrooxidation cell configured for reverse polarity, in accordance with some aspects of the present technology;

FIG. 6 illustrates an example advanced electro oxidation separation system, in accordance with some aspects of the present technology, for which the contents of U.S. application Ser. No. 17/327,781, titled System for Quick Response, Transportable, Stand-Alone System for Removing Volatile Compounds from Contaminated Fluid Streams, and Method of Use Thereof, filed on May 24, 2021, are incorporated by reference herein in their entirety;

FIG. 7 illustrates an example advanced electro oxidation separation system with electrode reaction chemistry, in accordance with some aspects of the present technology;

FIG. 8 illustrates an example produced water treatment (Total Oil and Gas and WSO Removal Facility) system, in accordance with some aspects of the present technology;

FIG. 9 illustrates an example produced water treatment system, in accordance with some aspects of the present technology;

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of’ what is specified, where the percentage includes 0.1, 1, 5, and 10 percent.

As will be appreciated, oil or gas wells may be considered dirty water production facilities in that in their operation the production and/or extraction of water is a part of the overall industrial process. For example, water may be obtained as a fraction of extracted or process oil and/or gas. In certain industrial processes/systems, where the input materials/intermediate materials are or are associated with fossilized organic matter, the arrangement or compositions of the oil/gas/water separation system and/or the chemical reaction of the industrial process result in “dirty water.” Even with the oil/gas/water separation stage, the dirty water typically still has an unacceptable non-polar concentration and an unacceptable polar concentration, and the dirty water needs to be further handled (whether it be processing it or storing/dumping/emitting it). The non-polar concentration is typically characterized as comprising free oils and/or dispersed oils. The polar concentration is typically characterized as comprising other organic and non-organic contaminants. More specifically, as produced or dirty water is processed and treated by conventional systems and methods, a discharge water stream is created.

Depending on industry standards, historical practice, internal or external regulations, and/or the geopolitical and geospatial characteristics defining the oil and gas well, the discharge water may be a point of interest and scrutiny. For example, conventional systems and methods tend to be exceptionally good a removing, capturing, and redirecting the non-polar fraction (e.g., oil and/or gas) of produced water. Even with conventional oil/gas/water separation techniques, the dirty water coming out of the oil/gas/water separation stage typically still has an unacceptable non-polar concentration and an unacceptable polar concentration.

In some aspects, dirty water processing techniques can include separators, hydro cyclones, flotation units, and are used to reduce free oils in what will become discharge water. In some aspects flotation units and media filters, also are used in an attempt to reduce dispersed oils in what will become discharge water.

Unfortunately, despite these processing techniques, the discharge water from these industrial processes/systems can still have a total oil concentration (e.g., non-polar concentration and polar concentration, taken together) or component concentration that exceed regulatory limits (for example, 29.0 parts per million for total oil concentration, USA. Furthermore, even if the discharge water has average contaminant concentrations below the regulatory limits, it is likely that real time contaminants concentrations vary widely (e.g. swing above the regulatory limits) throughout the useful life of these industrial processes/systems and, therefore, the harmful effects of the higher concentrations are not fully mitigated or avoided.

There are multiple reasons this happens. In one example, even if the discharge water has contaminant concentrations that are on average below regulatory limits, it is likely that contaminants have simply been redirected, moved, and/or concentrated into capture media or capture systems and that, when these capture media or capture systems are down/inoperative, or being changed-out, adjusted, maintained, or updated (all of these tend to be periodic and necessary), the discharge water will have contaminant concentrations that are above regulatory limits. In another example, even if the discharge water has contaminant concentrations that are on average below regulatory limits, it is likely that contaminants have simply been redirected, moved, and/or concentrated into capture media or capture systems and that although the discharge water concentrations are low, the concentrations in the emissions coming out of the processing systems for the capture media are above regulatory limits (or unregulated or under regulated). In another example, depending on the source of the fossilized organic matter (e.g., the location of an oil or gas wells), the produced water or dirty water and, therefore, the discharge water from these industrial processes/systems will have water soluble organics concentrations (characterized as polar) greater than what you would otherwise typically expect and that may contribute to overall contaminant concentration(s) that are above regulatory limits. In another example, depending on the tapped age of the fossilized organic matter (e.g., the age of an oil or gas well), the amount of produced water or dirty water extracted from the source will significantly increase and, therefore, the total throughput of these industrial processes/system also must significantly increase (e.g., be capable of scaling) or risk being incapable of managing the increased amount of produced water/dirty water and, consequently, risk having discharge water with contaminant concentrations that are above regulatory limits or a shutdown facility.

For those situations where the source of the fossilized organic matter (e.g., the location of an oil or gas wells) results in produced/dirty/discharge water with elevated water soluble organics concentrations, there may be additional industry conditions and forces that lead to problems and concerns. More specifically, elevated water soluble organics concentrations in produced water may be a source of value. For example, conventional systems and methods for processing produced/dirty water tend to be exceptionally good at removing, capturing, and redirecting the non-polar fraction (e.g., oil and/or gas and/or free oils) of produced water and less good at removing, capturing, and redirecting the water soluble organics fraction. In some conventional systems and methods for making the water soluble organic fraction accessible as free oils in the dirty water;

however, they typically involve the addition of acid to the aqueous stream. This can create problems especially for remote facilities (e.g., offshore oil or gas wells) with minimal storage space (both for supplies like concentrated acids or filter media, and for process streams or volumes like tanks or reservoirs), with minimal readily available resources, and with minimal man power (e.g., skeleton crews). Moreover, and unfortunately, despite these conventional dirty water processing techniques, the discharge water from the acidification stage tends to be acidic which creates its own problems (e.g., corrosion issues, environmental issues). As will be appreciated, dirty water is generally not naturally acidic, however, some current conventional methods of water treatment (e.g. removal of water soluble organics) utilize acids which can create a layer of WSOs that can be removed but leaves an acidic byproduct.

Accordingly, systems and methods described herein overcome conventional systems and methods for removing a polar fraction from a contaminated aqueous stream, and more particularly, for removing water soluble organics (WSOs) from a contaminated aqueous stream.

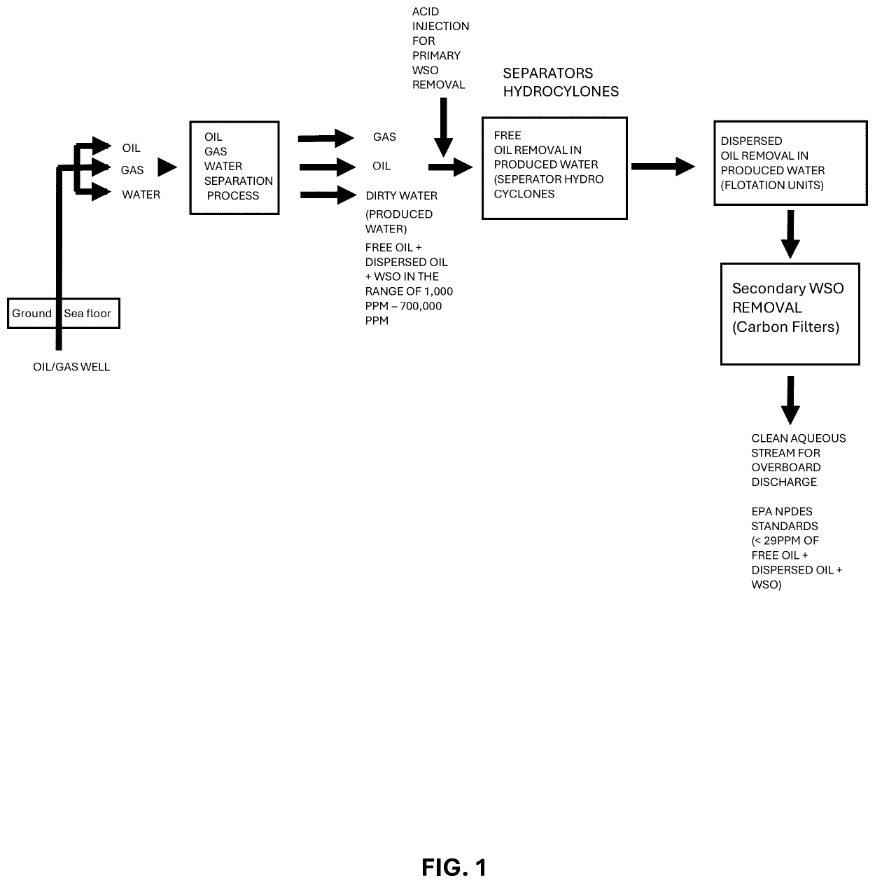

FIG. 1 illustrates a typical example oil, gas, water production process, that utilizes acid treatment and secondary removal of water soluble organics (WSOs) in accordance with some aspects of the present technology. In some aspects, WSO removal may be configured at an end stage of aqueous stream processing such as illustrated utilizing carbon filters or similar media filters. In some aspects an aqueous stream may be drawn from an oil/gas well, and processes to separate oil, gas and water from the aqueous stream drawn from a ground well or a sea floor. In some aspects, the dirty water (separated from oil and gas) may contain dispersed oil and WSOs in the range of 1,000-700,000 parts per million (PPM). In traditional methods of treating this produced water, acid is injected at the next stage for primary removal of WSOs. In the next stage of treatment, typically the free oils are removed by separators and hydrocyclones. In the next stage, dispersed oil is removed by flotation units. Finally, there is a secondary WSO removal stage utilizing carbon filters and/or other media filters. The “cleaned” aqueous stream is typically in the range of Environmental Protection Agency (EPA) National Polutant Discharge Elimination System (NPDES) standards of less than 29 PPM of free oil, dispersed oil and WSO combined. Traditional methods requires two stages for WSO treatment, these methods are costly i.e., acid and media filters and potentially hazardous i.e., storage and handling of acid.

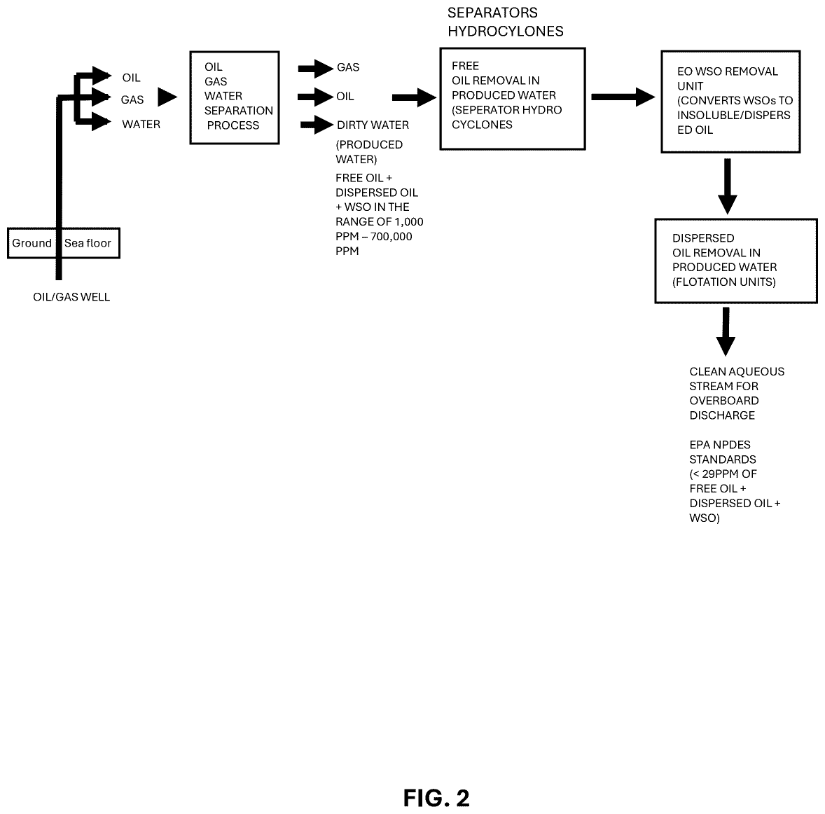

FIG. 2 illustrates an example single stage oil, gas, water production process, that utilizes an electro oxidation unit that converts WSOs dispersed oil without the use of acid treatment in accordance with some aspects of the present technology. In some embodiments, produced water, containing free oil, dispersed oil and WSOs in the range of 1,000 to 700,000 ppm may be sent directly to separators and hydrocyclones for free oil removal from the produced oil, without an acid treatment stage. Once the free oil has been removed by the separator hydrocyclones, the produced water may be sent to an EO unit to convert WSOs to insoluble and dispersed oil. In the next stage, the produced water with dispersed and insoluble water may be sent to flotation units to remove the dispersed oil. The cleaned water when tested contains less than 29 PPM of free oil, dispersed oil and WSO, and can be discharged back into the environment,

At a high level, embodiments of the present technology are directed towards systems and methods for removing water soluble organics (WSOs) from aqueous streams, for instance contaminated aqueous streams. For example, in some instances, a contaminated stream can be a discharge water stream that is emitted from produced water, sometimes referred to as dirty water, from industrial production or processing facilities, for example from oil or gas wells or from systems associated with or related to oil or gas wells. In some instances, water produced in these processes or that are considered discharge water, for example water volumes or streams that are periodically or continuously discharged from these facilities (e.g. the ocean), can in some instances have a high water soluble organics WSOs concentration or a high amount of WSOs).

In one aspect of the present technology, systems and methods are provided for creating a chemical reaction condition/tank/stage that is ideal for remote, “dirty water” production facilities, for example, off shore oil or gas platforms, which are characterized as having: minimal storage space (e.g., that have minimal storage space for supplies like concentrated acid(s), or for replacement filter media for quickly exhausted used filter media, and that have minimal space for by-pass or run-off streams or tanks/reservoirs); minimal readily-available resources (e.g., that have minimal capability to readily accommodate changes in contaminant concentration(s)/dirty water throughput or to accommodate changes in the total quantity of contaminants being processed); and minimal man power (e.g., that have minimal capability to supply man-hours to secondary systems and processes and related tasks).

In one aspect of the present technology, systems and methods are provided for creating a chemical reaction condition/tank/stage that keeps water soluble organics concentrations consistently and continuously (as much as possible) low, and that does not demand significant by-pass or run-off processes/systems/components/stages (or that demands no by-pass or run-off whatsoever) (by-pass or run-off systems/processes would likely cause the discharge water to have periodic/intermittent stretches of time when contaminant concentration(s) are above regulatory limits).

In one aspect of the present technology, systems and methods are provided for creating a chemical reaction condition/tank/stage that doesn't add any extra significant toxicity to the discharge water (especially if the discharge water is flowing directly to ecosystems or population centers, or commercial-use sources).

In one aspect of the present technology, systems and methods are provided for creating a chemical reaction condition/tank/stage that produces the least amount of hydroxyl radicals, as fast as possible (or relatively fast), using the lowest energy consumption possible (or relatively low energy consumption).

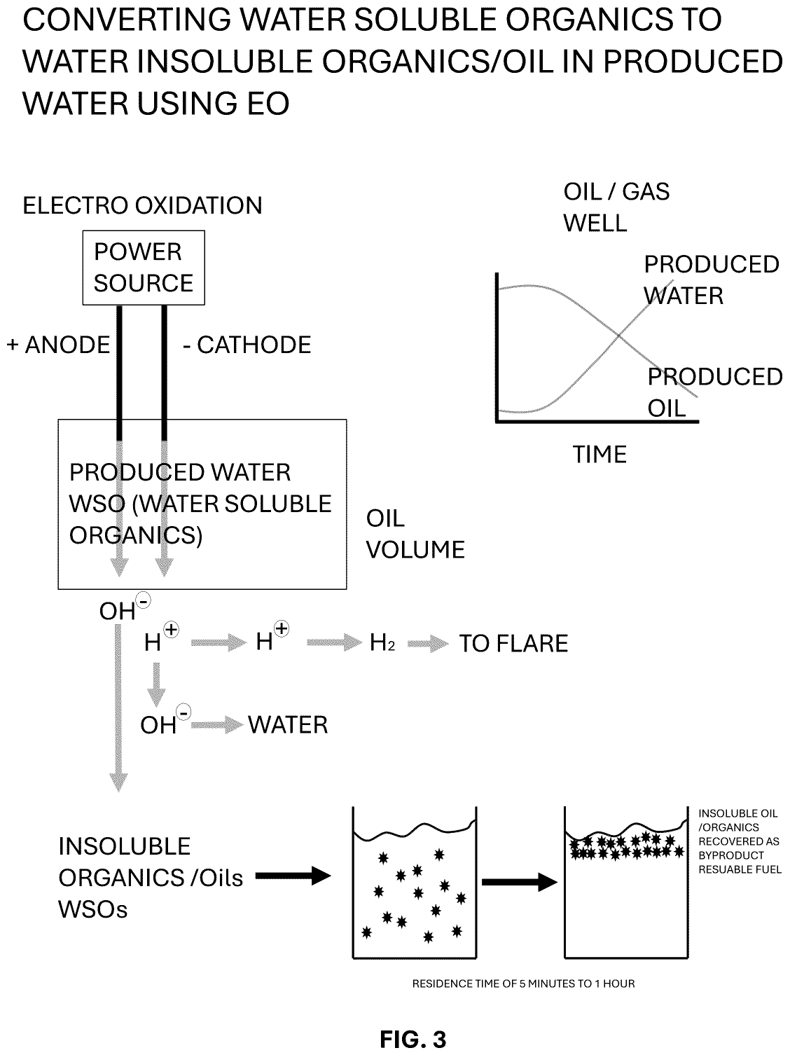

FIG. 3 illustrates example electrooxidation aspects of WSO removal, in accordance with some aspects of the present technology. According to some embodiments of the present invention, an implementation or process of utilizing an electro-cell (e.g. electrolyzer) having one or more channels can be used for the removal of WSOs from an aqueous stream. As shown in the graph of FIG. 3. the volume of oil that is produced from an oil source decreases over time, indicated by the downward sloping curve, as the amount of water increases over time indicated by the upward sloping curve. This graph illustrates that the concentration of oils, metals, and WSOs in the produced water changes over time, and thus the treatment protocols of the water must be monitored and adjusted accordingly to meet EPA NDPES standards.

In some embodiments, the EO system (as a unit) is configured with a power source typically in the range of 230/480V 3 phase at 60 hertz having a 100 KWh max operating power supplying power to a skid of EO cells. The produced water containing WSOs, oils metals, and other contaminants, may be sent to the EO system. Each cell in the system may be supplied power by an anode and a cathode titanium bus or titanium copper clad bus and carry a current in a range of 1-100 mA/^{cm2}. The anode and cathode bus are not limited to titanium and titanium copper clad materials to supply power to the electrodes of the system and may be any material capable of conducting electricity such as copper, bronze, brass, silver, aluminum, steel, nickel, and gold, or any combination of the like. Similarly, the electrodes are not limited to any specific material and may be made from any material capable of efficiently conducting power such as copper, bronze, brass, silver, aluminum, steel, nickel, and gold, or any combination of the like.

In some embodiments, when power is supplied to the anode and cathode of the EO cell, hydroxyl radicals OH⁻ and hydrogen H⁺ are produced from the produced water as shown in FIG. 3. A fraction of OH⁻ reacts with H⁺ to form water and a fraction of H⁺ reacts with H⁺ to form hydrogen. In some embodiments, the hydrogen gas may be sent to flare or may be recaptured and stored. In some embodiments, insoluble organics, oils and WSOs in the produced water precipitate out of suspension of the produced water with a residence time of 5-60 minutes, and may be recovered as a reusable byproduct. The insoluble oil organics may be re-used as fuel or oil byproduct.

In some embodiments, each cell in the system may be configured with a plurality of electrodes and each electrode may be supplied with a voltage in a range of 0.5-10 volts with a current density in a range of 10-70 milliamps/cm² surface area of electrode amps, however the EO system is not limited as such and may supply power within a range of 0.5-200V and within a current density range of 1 milliamps/cm² to 100 amps. Power provided to an anode and a cathode of the system, may further separate metals, oils, WSOs and other contaminants by precipitation or coagulation. The EO system is not limited to gravity fed precipitation and or coagulation and may be additionally be processed by stirring blades, agitators, or similar methods for enhancing precipitation or coagulation.

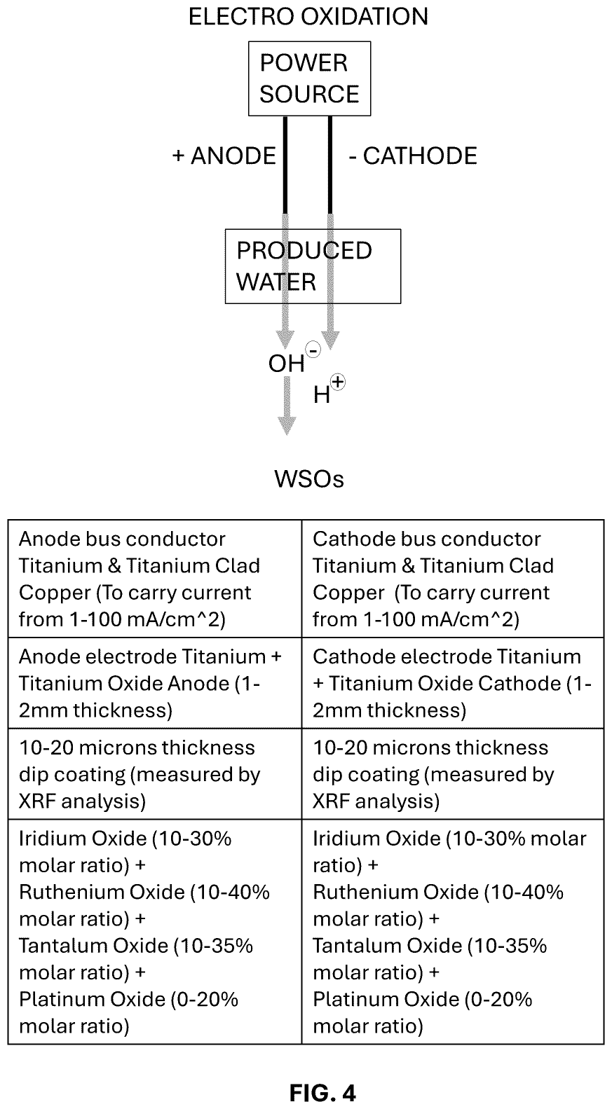

FIG. 4 illustrates example electrooxidation cell and MMO coatings in accordance with some aspects of the present technology. In one aspect, an electro-cell comprises a titanium anode and titanium cathode connected to a voltage source. The anode and cathode may be coated in a mixed metal oxide, namely, iridium oxide (a type of mixed metal oxide). Mixed metal oxide electrodes, also called dimensionally stable anodes, are devices with high conductivity and corrosion resistance for use as electrodes (specifically, anodes) in electrolysis. They are typically made by coating a substrate, such as a pure titanium plate or expanded mesh, with one or several kinds of metal oxides such as ruthenium oxide (RuO2), iridium (IV) oxide (lrO2), or platinum oxide (PtO2), which conducts electricity and catalyzes the reaction. Oxides containing two or more different kinds of metal cations are known as mixed metal oxides. Oxides can be binary, ternary and quaternary and so on with respect to the presence of the number of different metal cations. They can be further classified based on whether they are crystalline or amorphous. If the oxides are crystalline, then the crystal structure can determine the oxide composition. For instance, perovskites have the general formula ABO3; scheelites, ABO4; spinels, AB2O4; and palmeirites, A3B2O8. The different metal cations (MI and MIi) are present as Mln+−Ox and Mlln+−Ox polyhedra, which are connected in various possible ways, such as corner or edge sharing, forming chains MI-O-MII-O, MI-O-MI-O or MII-O-MII-O. Therefore, MMO coatings typically consist of an electro-catalytic conductive component that catalyzes the reaction to generate current flow, and bulk oxides (cheaper fill materials) that prevent corrosion of the substrate material (titanium). For cathodic protection applications, one primary electro catalysts that can be used is ruthenium oxide. Other oxides are a mixture of titanium dioxide (TiO2) and tantalum oxide (TaO5). Titanium dioxide and/or tantalum oxide can further provide an oxide film over the substrate material (e.g., the titanium) to prevent corrosion of the substrate.

In some embodiments, and as shown in the table in FIG. 4, an anode and cathode bus conductor of the EO system may be a titanium bus, or may be a titanium clad copper bus configured to carry 1-100 mA per cm² however, the system is not limited to lower voltages and can be provided with anode and bus conductors that can carry 1 mA per cm² to 200 A per cm² and any range in between depending on the treatment requirements of the produced water. In some aspects, an electrocell or electro-oxidation (EO) unit can be configured to operate in the range of 10-70 mA/cm² across an anode-cathode pair. In some aspects, an electrocell can be configured to operate at above 70 mA/cm². In some instances, the (EO) unit can operate at a voltage of 0.5-10 V. In some instances, the (EO) unit can operate at a voltage of 1-10V. In some aspects, the cathode can be Ti, can be MMO coated Ti, and/or can be Ti Boron doped diamond film coated. In some aspects, the anode can be MMO coated Ti, and/or can be Ti Boron doped diamond film coated. In some aspects, when in operation the polarity of at least an anode cathode pair can be reversed (e.g. designating the anode as the cathode and the cathode as the anode). The polarity may be reversed for any period of time not inconsistent with the present disclosure. In some aspects, the polarity may be reversed back to the original configuration.

In some embodiments an anode electrode may be configured as a titanium electrode+titanium oxide anode (1-2 mm thickness) and a cathode electrode may be configured as a titanium+titanium oxide cathode (1-2 mm thickness). The anode and the cathode may be dip coated, and have a coating thickness in the range of 10-20 microns measured by XRF analysis, however they are not limited as such and can have a 1 nanometer, 10 nanometer, 50 nanometer or any nanometer coating up to 1 micron in thickness or may have a thickness of 20 microns to 10 milli meters. In some embodiments the anode and cathode electrode coating may be configured with the molar ratios of iridium oxide at (10-30% molar ratio)+ruthenium oxide (10-40% molar ratio)+tantalum oxide (10-35% molar ratio)+platinum oxide (0-20% molar ratio), but is not limited as such and may have a single element from the group or a combination of elements from the group of iridium oxide, ruthenium oxide, tantalum oxide, or platinum oxide in any molar ratio of 0-100%.

In some aspects, the voltage/current provided to an electrode is typically about 5-10 V DC and about 25 amps passed across the channel between an anode and a cathode.

If metals, oils, or water soluble organics are in the dirty water, for example, then the system/process will produce hydrogen gas, molecular halogen (e.g., fluorine gas, chlorine gas, bromine gas, iodine gas), for example, and/or associated halide compounds or complexes (e.g., fluoride compounds or complexes or mixtures, chloride compounds or complexes or mixtures, bromide compounds or complexes or mixtures, iodide compounds or complexes or mixtures.

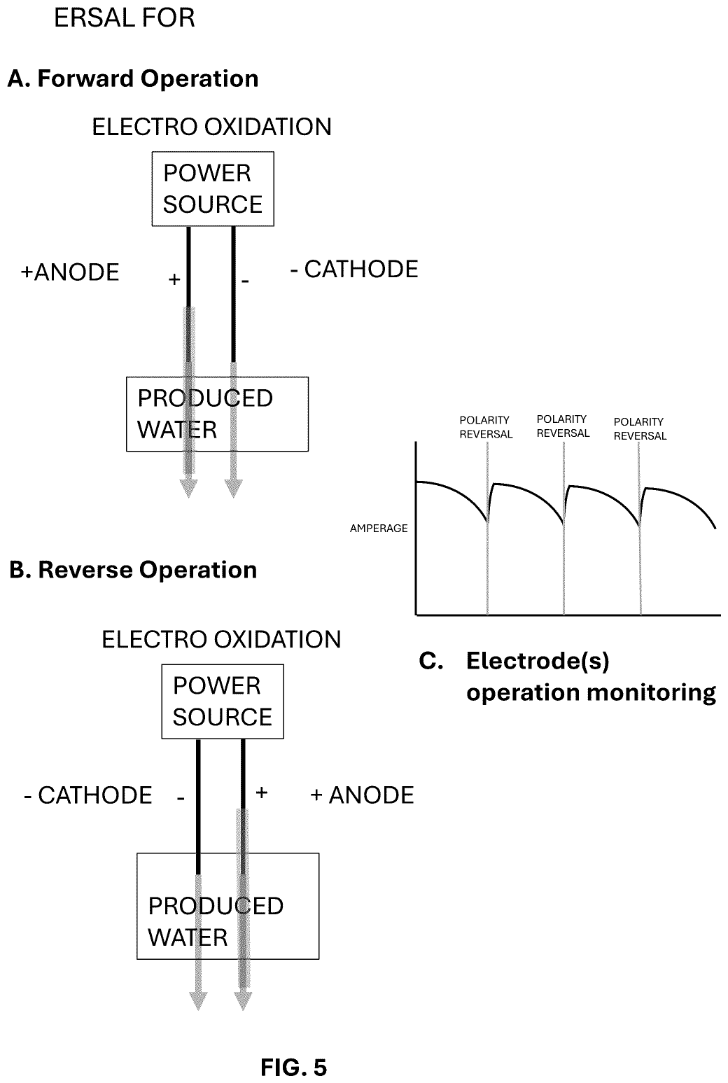

FIGS. 5A & B illustrates an example electrooxidation cell configured for reverse polarity, in accordance with some aspects of the present technology. In some embodiments of the technology, an electro-oxidation system and/or process is provided that incorporates a titanium anode and cathode coated with a mixed metal oxide combination having two or more of ruthenium oxide, iridium (IV) oxide, tantalum oxide, or any combination thereof. Mixed metal oxide, titanium anode and a titanium cathode connected to a voltage source. The mixed metal oxide, titanium anode is specifically coated in a mixed metal oxide combination (two or more mixed metal oxides, namely, those having rare earth metal elements) and platinum (distinguished from platinum oxide; platinum is a noble metal). If water soluble organics are in the produced water (waste water), for example, then the system/process will convert water soluble organics into free oil (available for recovery) without need for acid treatment to the dirty water. In some embodiments, the electro-oxidation system process can in some aspects only produces quantities of generally harmless carbon dioxide gas (e.g., hydrocarbons), generates clean water, does not add toxicity to dirty or discharge water, and does not require the need for the use of acids in treatment of dirty water. If dealing with a remote facility like an offshore oil or gas platform, then it demands significantly less electricity over time than conventional systems/processes.

In some embodiments, the electrocell can be configured to reverse the polarity of the electrodes to defoul/descale (as discussed above) the electrode that was once the anode and is now the cathode (after the reversal of polarity), such that the system/process did not have to be shut down or bypassed. In this way the system/process to continuously operate without a significant decrease in effectiveness or efficiency, even though the electrode is being maintained. The electrocell can be formed into a replaceable cartridge configuration such that it is an easy replacement piece when the electrodes (which switch from anode to cathode, and cathode to anode depending on direction of the current/polarity) reach the end of their useful life. In FIG. 5A, an example anode and cathode of an EO system is shown where a build up of material is formed on the anode of the system which occurs due to various factors, including the deposition of oxidation products, the adsorption of organic matter, and the formation of mineral scales on the electrode. This buildup of material on the electrode can be detected by monitoring the amperage draw of the electrode(s) over time as shown in the graph on FIG. 5C (electrode operation monitoring).

In FIG. 5C. amperage is shown on the x axis and time is on the y axis, and as can be seen here the operational characteristics of the amperage draw of the electrode may be saw tooth shaped, starting at a high amperage draw when the electrode is free of scaling or material build up, and amperage draw slowly decreases over time as the material builds up on the electrode, at which point the polarity of the electrodes may be switched and electrode de fouling/de scaling occurs and the amperage draw increases again. FIG. 5B illustrates a material buildup on the anode of the system when the EO system is in operation. The amperage draw of the anode electrode decreases over time as a build up of material occurs during operation as shown in FIG. 5C at which point, the polarity may be switched again back to the cathode to perform a de fouling/de scaling of the anode for a period of time. A build up of material on an electrode may occur over a period minutes to hours and anyone skilled in the art would understand that the polarity reversal process would be depend on the water being processed.

In some aspects, a coated titanium anode and an equivalently coated titanium cathode can be connected to a voltage source (in some aspects herein this can be referred to electro cell). In some aspects an electrocell can have a plurality of anodes and a plurality of cathodes. In some aspects the plurality of anodes and cathodes can alternate. In some aspects the distance between anodes and/or cathodes can be the same or can vary or can be tuned based on reaction feedback. In some aspects, the anode and the cathode are coated in a mixed metal oxide, namely, any of ruthenium oxide, iridium (IV) oxide, tantalum oxide, or those listed above and herein. This setup provides multiple advantages including: requires replacement electrodes but only after a significantly longer period of time (e.g., about one (1) year; requires significantly fewer types of supplies and less quantities of supplies, like filter media and replacement electrodes, and requires significantly less space to store and stage the supplies; it requires significantly fewer trips and less logistics for transportation and restocking of supplies; and it requires significantly less labor to manage the systems/processes than conventional systems or processes.

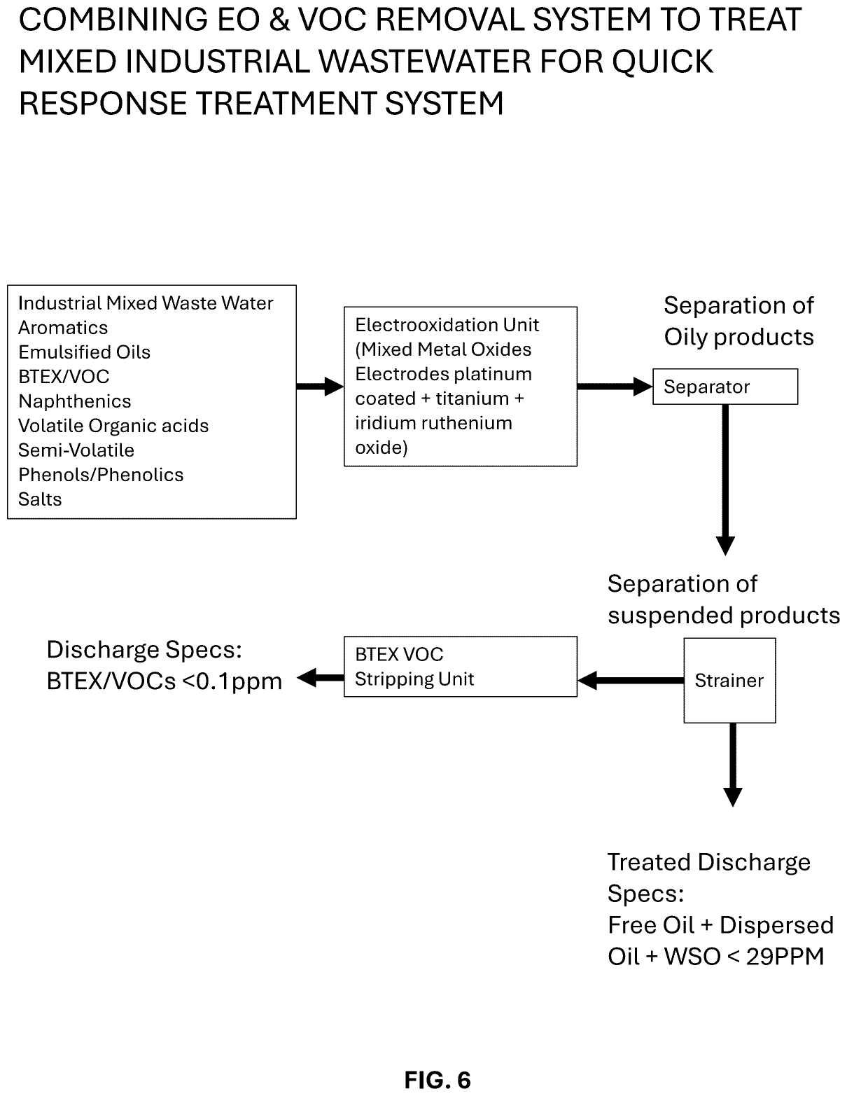

FIG. 6 illustrates an example advanced electro oxidation separation system that combines an EO system and VOC removal system (BTEX VOC stripping unit) to treat produced water or wastewater, in accordance with some aspects of the present technology, for which the contents of U.S. application Ser. No. 17/327,781, titled System for Quick Response, Transportable, Stand-Alone System for Removing Volatile Compounds from Contaminated Fluid Streams, and Method of Use Thereof, filed on May 24, 2021, are incorporated by reference herein in their entirety. The system may utilize electrooxidation process having electrodes that are coated in mixed metal oxides such as platinum coated, titanium and iridium, and ruthenium oxide that may process aromatics, emulsified oils, BTEX/VOC, napthenics, volatile organic acids, semi volatile phenols/phenolics, and salts. The process then may be configured to separate oily products by an oil separator. Suspended products may then be separated out by a strainer, and a treated discharge may contain TOG of 0-15 ppm which includes WSOs, or optionally, BTEX and VOX stripping extraction unit by further process the aqueous stream resulting in a discharge of BTEX/VOCs of less than 0.1 ppm.

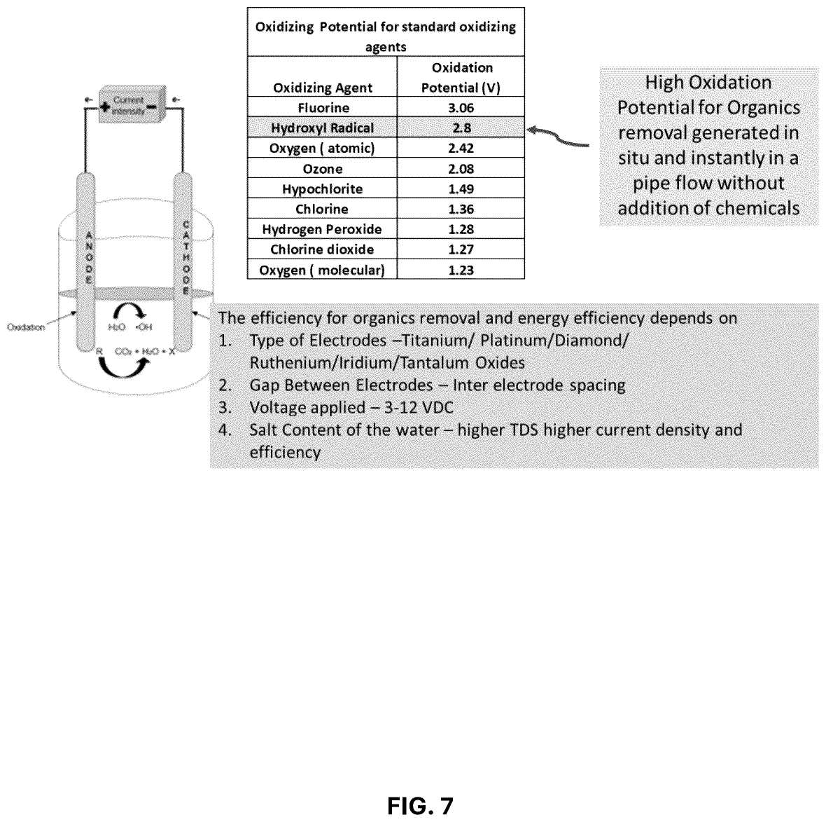

FIG. 7 illustrates an example advanced electro oxidation separation system with electrode reaction chemistry, in accordance with some aspects of the present technology.

In some other embodiments, mixed metal oxide and platinum, titanium anode, and a mixed metal oxide and platinum, titanium cathode connected can be to a voltage source (e.g. as an electrocell). The mixed metal oxide and platinum, titanium electrodes each specifically include a mixed metal oxide combination (two or more mixed metal oxides, namely, two or more of ruthenium oxide, iridium (IV) oxide, tantalum oxide, or those listed above and herein, or any combination thereof. Dirty water can be passed through a channel of the electrocell and WSOs can be removed. In some embodiments, the system is capable of high oxidation potential for organics removal generated in situ in a pipe flow without the addition of chemicals such as acid for the treatment of the aqueous stream. It is important to note that is not an exhaustive list of oxidizing potentials and oxidizing agents, and the system is not limited as such. Oxidation potentials for standard oxidizing agents associated with Fluorine may be in the range of 3V, hydroxyl radical in the range of 2.8V, oxygen in the range of 2.42V, hypochlorite in the range of 1.49V, chlorine in the range of 1.36V, hydrogen peroxide in the range of 1.28V, Chlorine dioxide in the range of 1.27V and molecular oxygen in the range of 1.23V.

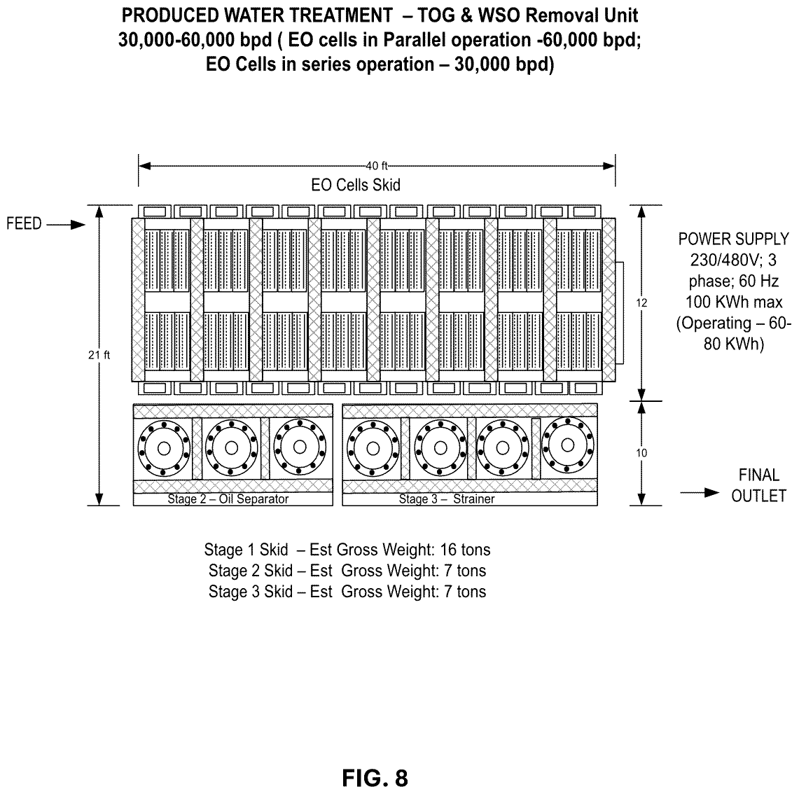

FIG. 8 illustrates an example produced water treatment (Total Oil and Gas and WSO Removal Facility) system, in accordance with some aspects of the present technology. In some embodiments, the TOG and WSO removal unit may be capable of 30,000 to 60,000 bpd as illustrated in FIG. 8. In some embodiments, the electrooxidation cells are configured as linearly spaced cells having cartridges and each cartridge may be configured with a plurality of electrodes in each cartridge of each cell. In some embodiments, as shown in FIG. 8 the inlet feed for the produced water is at the top of the EO unit. In some embodiments, the inlet feed is gravity fed or may be pumped into the EO unit. In some embodiments, the EO unit is supplied with a 230/480 V 3 phase electrical feed at 60 hertz, an operating voltage being between 60-80 KWh. Power supplied to each of the 16 cells configured in the EO system produces electrooxidation of the produced water that is gravity fed through the EO system. The system is not limited as such to 16 cells, and may have fewer than 16 or more than 16 cells, as anyone skilled in the art would understand that the number of EO cells in the unit would be determined by the volume of produced water to be cleaned. In some embodiments, each cell may be configured with 2 bus bars that supply power to 8-10 electrodes, however the system is not limited as such, and may be configured with fewer than 8 electrodes per cell, or more electrodes per cell such as 10-20, 20-30, 30-40, 40-50, 50-60, 60-70, 80-90, 90-100 or more.

In some embodiments, the produced water is sent to a stage 2 oil separator that separates the free and or dispersed oil that has been separated out of the produced water. In some embodiments, the produced water is sent to a stage 3 strainer that further separates out any other contaminates in the produced water such as metals, oils, and WSOs. In some embodiments the overall dimensions of the EO system may be 40 feet in length, 21 feet in height (when assembled), and a EO system may be configured as a 12 foot H unit and a stage 2 oil separator, and stage 3 strainer as a 10 ft height. an EO system can comprise one or more EO units. In some embodiments where two or more EO units are in operation, the parameters of each, and/or including polarity, can differ or be the same. In some embodiments, a stage 1 skid may have a gross weight of 16 tons, a stage 2 may have a gross weight of 7 tons, and a stage 3 may have a gross weight of 7 tons, but is not limited as such.

In some embodiments, a system comprising an EO unit can incorporate one or more hydrodynamic cavitation (HC) units. In some instances, an HC unit can be located before an EO unit. In some instances, an HC unit can be located after (e.g. downstream) from an EO unit. Any cavitation device not inconsistent with the present technology can be implemented in methods and systems disclosed herein.

In one embodiment, and in some aspects, the following information pertains: treatment of organic contaminants in wastewater has always been a great challenge in terms of efficiencies and costs. Emerging technologies such as Advanced Oxidation Process (AOPs), which harness the reactivity of hydroxyl/peroxygen radicals for organic contaminant mineralization has gained significant attention for many years. Cavitation methods, though considered a nuisance in flow systems, have shown great potential in wastewater treatment. In particular, hydrodynamic cavitation (HC), which is the formation of cavitation bubbles when a liquid is subjected to dynamic pressure reduction due to the presence of constriction in the flow system, has generated substantial interest due to their efficacy. The advantage of using HC based treatment technology is the fact that no additional capital equipment is required. It allows for slight modification of existing treatment systems to achieve better contaminant removal efficiencies. The mechanism of HC is based on pressure/temperature driven generation of hydroxyl (OH·) radicals. The cavity created downstream of constriction creates intense turbulence, liquid streaming at micro level as well as hot spots, which in turn generates significant amounts of hydroxyl radicals or peroxygen radicals required for organic pollutant degradation.

In one embodiment, and in some aspects, the following information pertains: Hydrodynamic cavitation when operated at the correct optimized conditions establishes the continuous generation of free radicals with maximum contact between the radicals and the pollutants in the shortest possible time. Thus, it reduces: (1) operational costs, (2) requirement for additional chemicals, (3) energy requirements and allows for effective treatment of large amounts of wastewater. It is typically estimated that effective hydrodynamic cavitation reduces operational costs by at least 50%. In one aspect, the key to the successful implementation of the technology is: (a) physiochemical properties of the fluid, (b) chemical substance to be degraded and; (c) type and geometry of the cavitation device.

In one aspect, a Hydrodynamic Cavitation Based Wastewater Treatment was developed, in particular, a RC-based process effluent treatment technology, for a petrochemical company discharging propylene glycol in the effluent. The process reduced the glycol concentration from 500 mg/L to ˜ 150 mg/L (discharge limit of 250 mg/L), and the TOC from ˜250 mg//L to 75 mg/L.

The geometry of the cavitating device affects the intensity of cavitation and, therefore, the efficiency of the HC process. A proper design for the fluid flow through the constriction is required as it influences pressure conditions during flow, thus the cavitation number and the intensity of the cavities generated. Additionally, constrictions should be located at appropriate positions such that enough cavities are generated for efficient degradation of the pollutant. The cavitating devices that are commonly used includes throttling valves, venturi, orifice plates, high-speed rotors, homogenizers, and vortex-diodes.

In one aspect, a HC unit is a vortex diode-based unit, which may be modified to include an orifice plate-based unit. The wastewater containing a 60% ethylene glycol, 40% propylene glycol (total glycol concentration ranging from 1000-10,000 mg/L). The total dissolved solids (TDS) will be comprised of 60% sodium chlorides, 10% sodium carbonate and 30% sodium sulfate. The TDS of the wastewater will be maintained at 30,000 mg/L (ppm).

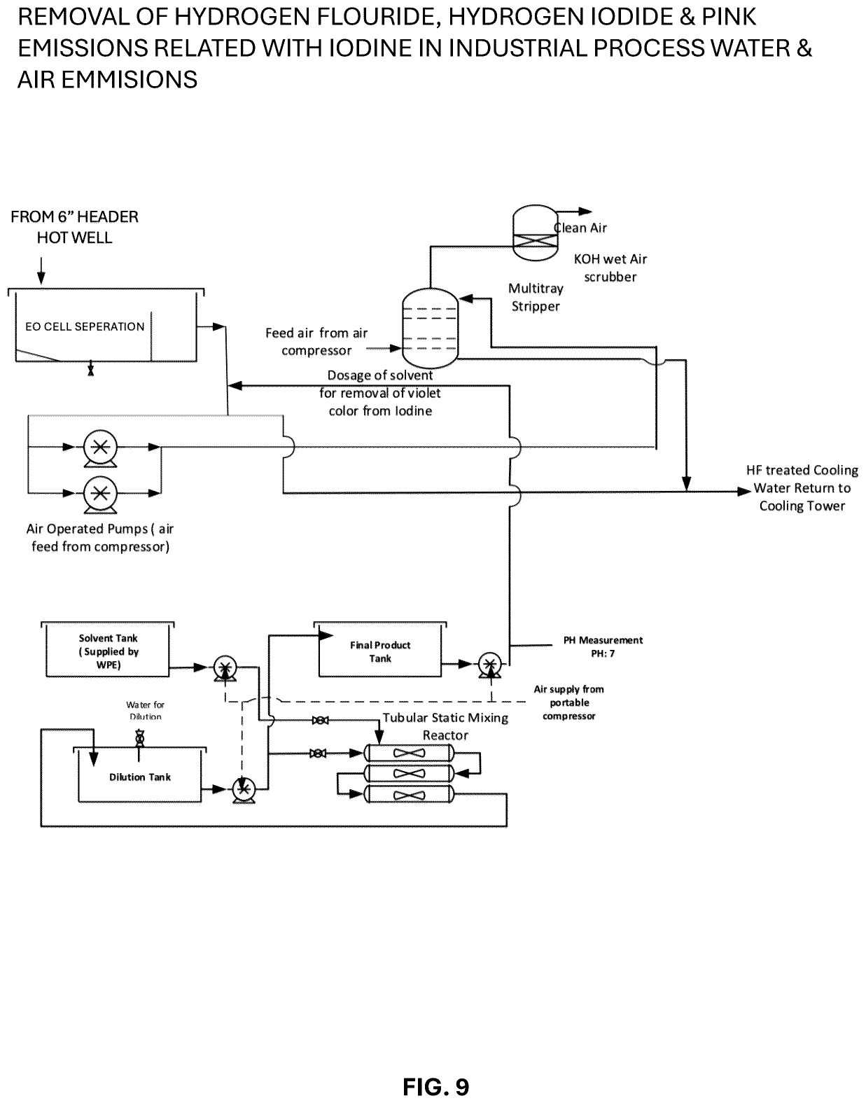

FIG. 9 illustrates an example produced water treatment system, in accordance with some aspects of the present technology. In some embodiments, an EO unit may be utilized to remove WSOs, metals, and oils from a produced water, and additionally that produced water may have other contaminants in the form of hydrogen fluoride, hydrogen iodide, and pink emissions related to iodine in industrial process water and air emissions. In some embodiment, an EO unit may be used in combination with a system for removing hydrogen fluoride, hydrogen iodide and iodine from the processed water.

In certain industrial systems and/or processes (produced water) for example in the production of ammonium phosphate (e.g. fertilizer), input and/or intermediate materials can comprise iodine and/or iodide concentrations which can in some instances result in violet or pink colored emissions or fumes, which in some instances can be due to, in part, by the arrangement of the system and/or processes and/or the chemical mechanisms of reaction processes in the system and/or processes. Accordingly, in some instances, the input and/or intermediate materials comprise phosphate ore (e.g. a base material or base ore) or rocks which can comprise a concentration of iodides. In some of these systems or processes, iodides can be converted to iodine(s). As will be appreciated, iodides may be colorless, while iodine(s) are violet and/or pink. Iodide is readily oxidized, in certain industrial processes or systems comprising input materials and/or intermediate materials having iodide concentrations, chemical processes or reactions in an overall process can result in the oxidation of iodides into iodine which can result in violet or pink colored emissions or fumes.

FIG. 9 illustrates a system that can be utilized in addition to an EO unit that may introduce one or more reducing agents, which can in some aspects prevent oxidation. In some aspects, a reducing agent can be about a pH of 7, or for example a pH from about 6 to 8. In one embodiment, a reducing agent composition comprises sodium sulfite (Na2SO3) and water (H2O). In some instances, reducing agent composition comprises 25% Na2SO3 and 75% H2O. In some instances, reducing agent composition is made up of a solution comprising 250 kg of Na2SO3 and 750 kg of H2O but is not limited as such, anyone skilled in the art would recognize that a reducing agent composition may depend on the concentration of contaminant of the produced water/industrial water further compositions and methods or utilizing reducing agents may be contemplated in U.S. application Ser. No. 19/066,746 filed by applicant and titled, systems and methods for preventing colored emissions in chemical processes, filed on Mar. 10, 2025 which is incorporated by reference herein in its entirety. In some embodiments, and as shown in FIG. 9. a solvent tank may be configured to supply a solvent, the solvent may be sent to a tubular static mixing reactor to be mixed in a dilution tank. And in some systems a dilution tank may be provided to dilute a solvent with H2O. A final product tank may be configured to store a diluted solvent, to be delivered to a fluid stream that has exited the EO unit for removal of hydrogen fluoride, hydrogen iodide and pink emission related to iodine in industrial processed water and air emissions.

Embodiments described herein can be understood more readily by reference to the examples described above. Elements, apparatus, and methods described herein, however, are not limited to any specific embodiment presented in the Examples. It should be recognized that these are merely illustrative of some principles of this disclosure, and are non-limiting. Numerous modifications and adaptations will be readily apparent without departing from the spirit and scope of the disclosure. Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

With the foregoing description, the disclosure herein has described the subject matter of the following numbered clauses:
Clause 1. A system for removing water soluble organics from a produced water and wastewater aqueous stream, including a titanium anode and a titanium cathode having a mixed metal oxide (MMO) coating; a channel between the anode and the cathode; and a power source configured to apply electricity across the channel.
Clause 2. The system of clause 1, including a plurality of anodes and a plurality of cathodes.
Clause 3. The system of clause 2, wherein the system is formed into a cartridge.
Clause 4. The system of clause 1, wherein the titanium anode MMO coating is iridium oxide and platinum oxide.
Clause 5. The system of clause 1, wherein the titanium anode MMO coating comprises iridium oxide, ruthenium oxide, tantalum oxide, and platinum oxide.
Clause 6. The system of clause 1, wherein the titanium cathode MMO coating is iridium oxide and Platinum oxide.
Clause 7. The system of clause 1, wherein the MMO includes iridium oxide, ruthenium oxide, tantalum oxide, and platinum oxide.
Clause 8. The system of clause 1, wherein a voltage of 0.5-10 Volts is applied across the channel.
Clause 9. The system of clause 1, wherein a current density of 10-70 milliamps/cm2 surface area of electrode amps is applied across the channel.
Clause 10. The system of clause 1, wherein the polarity of the anode and the cathode can be switched to maintain current density and reduce electrode fouling.
Clause 11. The system of clause 11, wherein the polarity switch frequency of the anode and cathode polarity is between 2 minutes and 360 minutes.
Clause 12. The system of clause 1, the removing of water soluble organics from a produced water and wastewater aqueous stream, the parts per million of water soluble organics in the produced water and wastewater aqueous stream is 0 to 29.
Clause 13. A method for removing water soluble organics from a produced water and wastewater aqueous stream, including submerging a system of claim 1 into an aqueous stream or a portion of an aqueous stream from another process, wherein the aqueous stream includes WSOs; removing at least a portion of the WSOs from the aqueous stream.
Clause 14. The method for removing water soluble organics from the aqueous stream according to clause 13, removing at least a portion of the WSOs from the aqueous stream by the system further including a plurality of anodes and a plurality of cathodes.
Clause 15. The method for removing water soluble organics from the aqueous stream according to clause 13, flowing, to remove at least a portion of the WSOs, the aqueous stream through a cartridge.
Clause 16. The method for removing water soluble organics from the aqueous stream according to clause 13, applying a voltage of 0.5-10 volts across the channel.
Clause 17. The method for removing water soluble organics from the aqueous stream according to clause 13, applying a 10-70 milliamps/cm² surface area of electrode across the channel.
Clause 18. The method for removing water soluble organics from the aqueous stream according to clause 13, flowing, to remove at least a portion of the WSOs, the anode MMO coating is iridium oxide and Platinum oxide.
Clause 19. The method for removing water soluble organics from the aqueous stream according to clause 13, flowing, to remove at least a portion of the WSOs, the anode MMO coating includes iridium oxide, ruthenium oxide, tantalum oxide, and platinum oxide.
Clause 20. The method for removing water soluble organics from the aqueous stream according to clause 13, flowing, to remove at least a portion of the WSOs, the titanium cathode comprises an MMO coating.
Clause 21. The method for removing water soluble organics from the aqueous stream according to clause 13, flowing, to remove at least a portion of the WSOs, the titanium cathode MMO coating is iridium oxide and Platinum oxide.
Clause 22. The method for removing water soluble organics from the aqueous stream according to clause 13, flowing, to remove at least a portion of the WSOs, the titanium cathode MMO comprises iridium oxide, ruthenium oxide, tantalum oxide, and platinum oxide.
Clause 23. The method for removing water soluble organics from the aqueous stream according to clause 13, maintaining the anode and the cathode of the system by switching the polarity of the anode and the cathode to maintain current density and reduce fouling of the electrodes.
Clause 24. The method for removing water soluble organics from the aqueous stream according to claim 13, removing water soluble organics from a produced water and wastewater aqueous stream, the parts per million of water soluble organics in the removed produced water and wastewater aqueous stream is 0 to 29.

1. A system for removing water soluble organics from a produced water and wastewater aqueous stream, comprising: a titanium anode and a titanium cathode comprising a mixed metal oxide (MMO) coating;
a channel between the titanium anode and the titanium cathode; and
a power source configured to apply electricity across the channel.

2. The system of claim 1, comprising a plurality of anodes and a plurality of cathodes.

3. The system of claim 2, wherein the system is formed into a cartridge.

4. The system of claim 1, wherein a titanium anode MMO coating is iridium oxide and platinum oxide.

5. The system of claim 1, wherein a titanium anode MMO coating comprises iridium oxide, ruthenium oxide, tantalum oxide, and platinum oxide.

6. The system of claim 1, wherein a titanium cathode MMO coating is iridium oxide and Platinum oxide.

7. The system of claim 1, wherein the MMO comprises iridium oxide, ruthenium oxide, tantalum oxide, and platinum oxide.

8. The system of claim 1, wherein a voltage of 0.5-10 Volts is applied across the channel.

9. The system of claim 1, wherein a current density of 10-70 milliamps/cm² surface area of electrode amps is applied across the channel.

10. The system of claim 1, wherein a polarity of the titanium anode and the titanium cathode can be switched to maintain current density and reduce electrode fouling.

11. The system of claim 10, wherein a polarity switching frequency of the titanium anode and titanium cathode polarity is between 2 minutes and 360 minutes.

12. The system of claim 1, the removing of water soluble organics from the produced water and wastewater aqueous stream, a parts per million of water soluble organics in the produced water and wastewater aqueous stream is 0 to 29.

13. A method for removing water soluble organics from the produced water and wastewater aqueous stream, comprising: submerging the system of claim 1 into an aqueous stream or a portion of the aqueous stream from another process, wherein the aqueous stream comprises WSOs; removing at least a portion of the WSOs from the aqueous stream.

14. The method for removing water soluble organics from the produced water and wastewater aqueous stream according to claim 13, removing at least a portion of the WSOs from the aqueous stream by the system further comprising a plurality of anodes and a plurality of cathodes.

15. The method for removing water soluble organics from the produced water and wastewater aqueous stream according to claim 13, flowing, to remove at least a portion of the WSOs, the produced water and wastewater aqueous stream through a cartridge.

16. The method for removing water soluble organics the produced water and wastewater aqueous stream according to claim 13, applying a voltage of 0.5-10 volts across the channel.

17. The method for removing water soluble organics from the produced water and wastewater aqueous stream according to claim 13, applying a 10-70 milliamps/cm² surface area of electrode across the channel.

18. The method for removing water soluble organics from the produced water and wastewater aqueous stream according to claim 13, flowing, to remove at least a portion of the WSOs, a titanium anode MMO coating is iridium oxide and Platinum oxide.

19. The method for removing water soluble organics from the produced water and wastewater aqueous stream according to claim 13, flowing, to remove at least a portion of the WSOs, a titanium anode MMO coating comprises iridium oxide, ruthenium oxide, tantalum oxide, and platinum oxide.

20. The method for removing water soluble organics from the produced water and wastewater aqueous stream according to claim 13, flowing, to remove at least a portion of the WSOs, the titanium cathode comprises an MMO coating.

21. The method for removing water soluble organics from the produced water and wastewater aqueous stream according to claim 13, flowing, to remove at least a portion of the WSOs, a titanium cathode MMO coating is iridium oxide and Platinum oxide.

22. The method for removing water soluble organics from the produced water and wastewater aqueous stream according to claim 13, flowing, to remove at least a portion of the WSOs, the titanium cathode MMO comprises iridium oxide, ruthenium oxide, tantalum oxide, and platinum oxide.

23. The method for removing water soluble organics from the produced water and wastewater aqueous stream according to claim 13, maintaining the titanium anode and the titanium cathode of the system by switching a polarity of the titanium anode and the titanium cathode to maintain current density and reduce fouling of the titanium anode and the titanium cathode.

24. The method for removing water soluble organics from the produced water and wastewater aqueous stream according to claim 13, removing water soluble organics from a produced water and wastewater aqueous stream, a parts per million of water soluble organics in the removed produced water and wastewater aqueous stream is 0 to 29.
